(19) United States
(12) Patent Application Publication
(10) Pub. No.: US 2026/0168377 A1
(43) Pub. Date: Jun. 18, 2026

(54) PRE-SPLIT ROOF CAVING METHOD BASED ON COLLABORATION OF FOAM FRACTURING AND BLASTING FOR COAL MINES

(71) Applicant: SHANDONG UNIVERSITY OF SCIENCE AND TECHNOLOGY, QINGDAO (CN)

(72) Inventors: QIMING HUANG, QINGDAO (CN); XU WANG, QINGDAO (CN); GANG WANG, QINGDAO (CN); WEIMIN CHENG, QINGDAO (CN); HONGZHAN LIU, QINGDAO (CN); DEFENG HOU, QINGDAO (CN); JUNYANG PAN, QINGDAO (CN); HAONAN SHI, QINGDAO (CN); CHENGYU MAO, QINGDAO (CN)

(21) Appl. No.: 19/089,842

(22) Filed: Mar. 25, 2025

(30) Foreign Application Priority Data
Dec. 13, 2024 (CN) 202411838802.X

(51) Int. Cl. E21C 37/12; C09K 8/64; C09K 8/70

(52) U.S. Cl. CPC E21C 37/12; C09K 8/64; C09K 8/703

(57) ABSTRACT

Disclosed is a pre-split roof caving method based on the collaboration of foam fracturing and blasting for coal mines, including: S1, construction of a borehole; S2, preparation of a foam fracturing fluid; S3, fracturing; and S4, roof caving by blasting. Foam fracturing and blasting are combined, and a great many of fractures are generated in a roof rock stratum by foam fracturing, such that the strength of the roof rock stratum is reduced, a blasting space is provided for blasting, pre-caving of a roof is realized, and safety problems caused by difficult caving of a tight roof in a goaf are avoided.

### BACKGROUND OF THE INVENTION

### 1. Technical Field

The invention belongs to the technical field of foam fracturing and blasting, and particularly relates to a pre-split roof caving method based on the collaboration of foam fracturing and blasting for coal mines.

### 2. Description of Related Art

For a mining face, the stability of the roof has a direct impact on the mining continuity. The difficulty in caving of tight roofs becomes a great potential safety hazard in operation on the mining face. This not only affects continuous proceeding of excavation of the working face, but also affects a series of subsequent production steps such as transportation and ventilation.

To improve the stability of a roof, the blasting technology is widely used in China and foreign countries at present to promote the roof to cave, that is, shock waves and stress waves generated by an explosive explosion act on roof rock to destroy the integrity of the rock to allow the roof to cave under the dual action of self-gravity and blasting force. This operation mainly aims to prevent large-area suspension of the roof to avoid accidents caused by sudden caving of the roof and also facilitates the disposal of a goaf and proceeding of subsequent mining work. Because the explosion can generate powerful shock waves, the crushing effect on the structure of a rock stratum is good. However, the controllability of the blasting range in traditional blasting-based roof caving is poor. When a local region of the roof caves or deforms seriously due to blasting, adjacent roof rock may cave under the domino effect due to the lack of original support, making it difficult to control the blasting range and affecting the safety of underground working personnel and the operation of equipment.

### BRIEF SUMMARY OF THE INVENTION

The invention aims to provide a pre-split roof caving method based on the collaboration of foam fracturing and blasting for coal mines. The pre-split roof caving method combines the foam fracturing technique and the blasting technique, a great many of fractures are generated in a roof rock stratum by foam fracturing, such that the strength of the roof rock stratum is reduced, a blasting space is provided for blasting, the safety of roof caving of a mining face is guaranteed, pre-caving of a roof is realized, and safety problems caused by difficult caving of a tight roof in a goaf are avoided.

For this purpose, the invention adopts the following technical solution: a pre-split roof caving method based on the collaboration of foam fracturing and blasting for coal mines includes the following steps:
S1: construction of a borehole: constructing the borehole for foam fracturing fluid transportation and pressure boosting in an appropriate position of a top rock stratum of a coal bed according to characteristics of a roof rock stratum and requirements of a coal mining process;
S2: preparation of a foam fracturing fluid: preparing and foaming the foam fracturing fluid by means of a foam preparation device, and injecting a combustible gas during foaming of the foam fracturing fluid;
S3: fracturing: arranging a fracturing system in the vicinity of the borehole, injecting the foamed foam fracturing fluid into the borehole by means of the fracturing system to destroy an interior of the roof rock stratum to form fractures with a specified size, and enabling the foamed foam fracturing fluid to enter the fractures under the action of the fracturing system; and
S4: roof caving by blasting: when the fractures in the roof rock stratum satisfy blasting requirements, stopping injection of the foam fracturing fluid, and then performing ignition for blasting.

Preferably, the foam fracturing fluid includes, by weight, 5-6 parts of diesel oil, 0.5-1 part of guar gum, 1-2 parts of ammonium nitrate and 1-2 parts of rock debris.

Further preferably, the rock debris is obtained by crushing crumbly rock generated during drilling and has a granularity of 40-80 meshes.

Further preferably, the foam preparation device includes a preparation container used for mixing components and a foaming container used for foaming the foam fracturing fluid, the foaming container has a sealed state, an electric stirring device is arranged in the foaming container, a vacuum hole for realizing a vacuum state of the foaming container and a gas inlet for the combustible gas to enter the foaming container are formed in the foaming container, the gas inlet is formed in a bottom of the foaming container, a feed inlet is formed in the foaming container, the vacuum hole is connected to a vacuum pump by means of a vacuum line, the gas inlet is connected to a combustible gas injection system by means of a gas inlet line, check valves are arranged on the vacuum line and the gas inlet line, and the combustible gas injection system includes a storage cylinder for storing the combustible gas and a buffer tank and a pressure gauge which are arranged on the gas inlet line.

Further preferably, preparation steps in S2 include: pouring the diesel oil into a preparation container, adding the guar gum, and stirring until the guar gum is completely dissolved; adding the ammonium nitrate, and stirring a solution evenly; keeping a foaming container in a sealed state, and pumping air out of the foaming container by means of a vacuum pump; and transferring the evenly stirred solution into the foaming container, stirring by means of an electric stirring device, injecting the combustible gas by means of a gas inlet, and adding the rock debris multiple times by means of a feed inlet until foaming is completed.

Further preferably, the combustible gas is acetylene.

Further preferably, the fracturing system includes a fracturing operation control system, a high-pressure pump, a fracturing line, an electric ignition device and a storage container, the storage container has a sealed state and is used for storing the foamed foam fracturing fluid, the fracturing line has an end connected to the storage container as well as an end stretching into the borehole, the high-pressure pump is arranged on the fracturing line, an electric ignition connecting wire of the electric ignition device is laid in the borehole together with a high-pressure line, and the fracturing operation control system is electrically connected to the high-pressure pump and the electric ignition device and used for controlling on/off and an operating pressure of the high-pressure pump and operation of the electric ignition device.

The invention has the following beneficial effects:
1) A great many of fractures are generated in the rock stratum by means of foam fracturing, and the fractures not only destroy the integrity of the rock stratum and reduce the strength of the rock stratum, but also expand the distribution range of the foam fluid in the fractures, thus realizing a wide distribution of an explosive source which is mainly prepared from the combustible gas; because the range and porosity of the fractures can be controlled by the depth of the borehole, the fracturing pressure and other conditions of foam fracturing, foam fracturing is controllable, thus guaranteeing the accuracy in the process of roof caving by blasting.
2) After fracturing is completed, blasting is performed by ignition; because the foam fracturing fluid is full of the combustible gas, the foam fracturing fluid can explode to further expand the fractures under the combined action of mechanical, thermochemical and vibratory pulses in the borehole and the fractures, thus improving the connectivity of the fractures; in addition, shock waves generated by blasting can promote the roof rock stratum to vibrate to realize pre-caving of a roof, thus guaranteeing the safe operation of a mining face.
3) The invention gives full play to the controllability of the fracturing range of foam fracturing and the high efficiency of high-energy blasting, thus greatly improving the controllability of the blasting range and effect, effectively controlling the stability of the roof rock stratum, reducing roof collapsing, weighting and other accidents, and providing a safer environment for coal mining.

### BRIEF DESCRIPTION OF THE SEVERAL VIEWS OF THE DRAWINGS

FIG. 1 is a schematic diagram of the collaborative operation of foam fracturing and blasting according to the invention.

FIG. 2 is a schematic diagram of fractures generated by foam fracturing and a blasting structure according to the invention.

FIG. 3 is a schematic diagram of preparation, foaming and injection of a foam fracturing fluid according to the invention.

### DETAILED DESCRIPTION OF THE INVENTION

The invention is further described below in conjunction with embodiments and accompanying drawings.

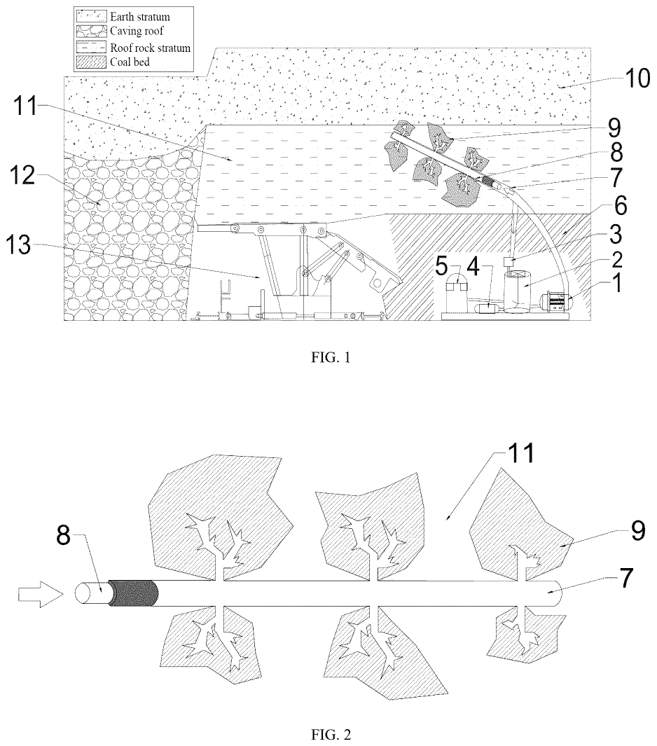

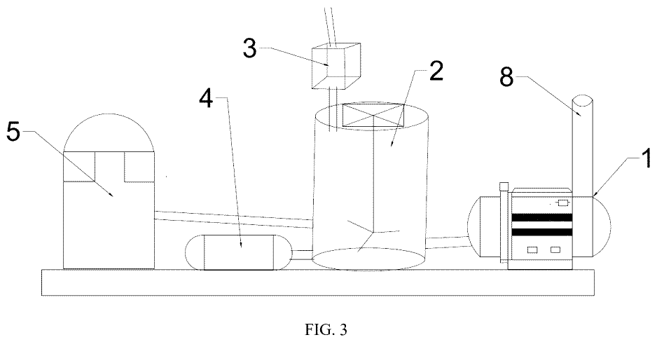

As shown in FIGS. 1-3, a pre-split roof caving method based on the collaboration of foam fracturing and blasting for coal mines includes the following steps:
Step 1, construction of a borehole: the borehole 7 for foam fracturing fluid transportation and pressure boosting is constructed in an appropriate position of a top rock stratum of a coal bed according to characteristics of a roof rock stratum and requirements of a coal mining process.

Specifically, in conjunction with the mechanical properties of a roof of the coal bed, the fracturing radius is designed; then, according to a construction scheme, a stress-concentrated position of the roof rock stratum 11 is selected, and drilling is performed at a high construction position of an underground tunnel; when the depth of the borehole satisfies fracturing requirements, drilling is stopped, and withdrawing is performed, that is, a drill bit and a drill stem are lifted and detached in sequence until withdrawing is completed; after that, the borehole is cleaned.
Step 2, preparation of a foam fracturing fluid: the foam fracturing fluid is prepared and foamed by means of a foam preparation device, and a combustible gas is injected during foaming of the foam fracturing fluid. Step 2 may be performed instantly after Step 1.

According to the characteristics of coal mines, the combustible gas may be acetylene. The foam fracturing fluid includes, by weight, 5-6 parts of diesel oil, 0.5-1 part of guar gum, 1-2 parts of ammonium nitrate and 1-2 parts of rock debris. Wherein, the diesel oil, as a foam base solution, has an ignition effect. The guar gum has a thickening effect and after being added, can improve the viscosity of the original fluid to increase the foaming rate and output, and preferably, hydroxypropyl guar gum is adopted. The ammonium nitrate reacts at a high temperature to release a large quantity of oxygen, thus being used as a combustion improver. The rock debris is used for improving the stability and strength of foam during foaming. Preferably, the rock debris is obtained by crushing crumbly rock generated during drilling and has a granularity of 40-80 meshes, and other rock debris not in line with the granularity requirement is treated as waste and used for backfilling of a goaf.

Wherein, the foam preparation device includes a preparation container 5 used for mixing components and a foaming container 2 used for foaming the foam fracturing fluid, the foaming container has a sealed state, an electric stirring device is arranged in the foaming container and used for stir-foaming, and a feed inlet is formed in the foaming container and used for adding a foam stabilizer (rock debris) in the foaming process. A vacuum hole for realizing a vacuum state of the foaming container and a gas inlet for the combustible gas to enter the foaming container are formed in the foaming container, the gas inlet is formed in the bottom of the foaming container, the vacuum hole is connected to a vacuum pump by means of a vacuum line, the gas inlet is connected to a combustible gas injection system by means of a gas inlet line, and check valves are arranged on the vacuum line and the gas inlet line. Specifically, the combustible gas injection system includes a storage cylinder 4 for storing the combustible gas and a buffer tank and a pressure gauge which are arranged on the gas inlet line. The electric stirring device belongs to the prior art.

A specific preparation process is as follows: the diesel oil is poured into the preparation container, the guar gum is added, and stirring is performed until the guar gum is completely dissolved; the ammonium nitrate is added, and a solution is evenly stirred; the foaming container is kept in the sealed state, and air is pumped out of the foaming container by means of the vacuum pump; the evenly stirred solution is transferred into the foaming container, stirring is performed by means of the electric stirring device, the combustible gas is injected by means of the gas inlet and the combustible gas injection system, and the rock debris is added multiple times by means of the feed inlet until foaming is completed.

Wherein, the rock debris is prepared as follows: rock debris generated during drilling is directly conveyed into a crusher to be crushed, the crushed rock debris is placed in a sieve, and rock debris with a granularity of 40-80 meshes is screened out to be stored. To facilitate the addition of the rock debris, a rock debris adding device is arranged above the feed inlet, and the rock debris adding device adds the rock debris to the foaming container multiple times as required. Preferably, a transportation line is arranged between the preparation container and the foaming container.
Step 3, fracturing: a fracturing system is arranged in the vicinity of the borehole, the foamed foam fracturing fluid is injected into the borehole by means of the fracturing system to destroy the interior of the roof rock stratum to form fractures with a specified size, and the foamed foam fracturing fluid enters the fractures under the action of the fracturing system.

Wherein, the fracturing system includes a fracturing operation control system, a high-pressure pump 1, a fracturing line 8, an electric ignition device and a storage container 2, the storage container has a sealed state and is used for storing the foamed foam fracturing fluid, and preferably, the storage container is a foaming container. One end of the fracturing line is connected to the storage container, and the other end of the fracturing line stretches into the borehole. The high-pressure pump is arranged on the fracturing line. An electric ignition connecting wire of the electric ignition device is laid in the borehole together with a high-pressure line. The fracturing operation control system is electrically connected to the high-pressure pump and the electric ignition device and used for controlling on/off and an operating pressure of the high-pressure pump and operation of the electric ignition device.

To facilitate overall operation control, the fracturing operation control system is also electrically connected to the stirring device, the combustible gas injection system and the vacuum pump to realize operation control of a whole device. The fracturing operation control system adopts a structure with information transmitting, receiving and processing functions in the prior art and further includes an operation panel with information exchange and input functions.

The storage container and the foaming container are integrated and the rock debris adding device is arranged above the feed inlet to obtain an integrated device for fracturing, such that the structure is simplified, the cost is reduced, and the foam fracturing efficiency is greatly improved; rock debris is crushed, screened and then added to foam to improve the stability of the foam, such that the utilization rate of the foam is increased, thus realizing economical and efficient fracturing.
Step 4, roof caving by blasting: when the fractures in the roof rock stratum satisfy blasting requirements, injection of the foam fracturing fluid is stopped, and then ignition is performed for blasting.

A specific operation is as follows: when the fractures in the roof rock stratum satisfy blasting requirements, the high-pressure pump stops, a high-pressure hose is taken out, and then the electric ignition device is started for ignition to perform blasting. Because a large proportion of foam will break to release a large quantity of acetylene, the concentration of acetylene in the factures will increase rapidly to reach an explosion concentration range; at the same time, the diesel, as the foam base solution, has an ignition effect, the gas in the fractures explodes instantly in the presence of a combustion source, and the ammonium nitrate in the foam fluid reacts at a high temperature to release a large quantity of oxygen, thus further improving the blasting effect; the fractures can be further expanded under the combined action of mechanical, thermochemical and vibratory pulses in the blasting process, thus improving the connectivity of the fractures; moreover, shock waves generated by blasting make the roof rock stratum to vibrate to promote the rock stratum to fracture and cave.

FIG. 1 is a schematic diagram of the collaborative operation of fracturing and blasting performed in a coal bed in a case where a foam fracturing fluid preparation, foaming and injection integrated device is adopted.

What is claimed is:

1. A pre-split roof caving method based on the collaboration of foam fracturing and blasting for coal mines, comprising the following steps:
S1: construction of a borehole: constructing the borehole for foam fracturing fluid transportation and pressure boosting in an appropriate position of a top rock stratum of a coal bed according to characteristics of a roof rock stratum and requirements of a coal mining process;
S2: preparation of a foam fracturing fluid: preparing and foaming the foam fracturing fluid by means of a foam preparation device, and injecting a combustible gas during foaming of the foam fracturing fluid;
S3: fracturing: arranging a fracturing system in the vicinity of the borehole, injecting the foamed foam fracturing fluid into the borehole by means of the fracturing system to destroy an interior of the roof rock stratum to form fractures with a specified size, and enabling the foamed foam fracturing fluid to enter the fractures under the action of the fracturing system; and
S4: roof caving by blasting: when the fractures in the roof rock stratum satisfy blasting requirements, stopping injection of the foam fracturing fluid, and then performing ignition for blasting.

2. The pre-split roof caving method based on the collaboration of foam fracturing and blasting for coal mines according to claim 1, wherein the foam fracturing fluid comprises, by weight, 5-6 parts of diesel oil, 0.5-1 part of guar gum, 1-2 parts of ammonium nitrate and 1-2 parts of rock debris.

3. The pre-split roof caving method based on the collaboration of foam fracturing and blasting for coal mines according to claim 2, wherein the rock debris is obtained by crushing crumbly rock generated during drilling and has a granularity of 40-80 meshes.

4. The pre-split roof caving method based on the collaboration of foam fracturing and blasting for coal mines according to claim 1, wherein the foam preparation device comprises a preparation container used for mixing components and a foaming container used for foaming the foam fracturing fluid, the foaming container has a sealed state, an electric stirring device is arranged in the foaming container, a vacuum hole for realizing a vacuum state of the foaming container and a gas inlet for the combustible gas to enter the foaming container are formed in the foaming container, the gas inlet is formed in a bottom of the foaming container, a feed inlet is formed in the foaming container, the vacuum hole is connected to a vacuum pump by means of a vacuum line, the gas inlet is connected to a combustible gas injection system by means of a gas inlet line, check valves are arranged on the vacuum line and the gas inlet line, and the combustible gas injection system comprises a storage cylinder for storing the combustible gas and a buffer tank and a pressure gauge which are arranged on the gas inlet line.

5. The pre-split roof caving method based on the collaboration of foam fracturing and blasting for coal mines according to claim 3, wherein preparation steps in S2 comprise: pouring the diesel oil into a preparation container, adding the guar gum, and stirring until the guar gum is completely dissolved; adding the ammonium nitrate, and stirring a solution evenly; keeping a foaming container in a sealed state, and pumping air out of the foaming container by means of a vacuum pump; and transferring the evenly stirred solution into the foaming container, stirring by means of an electric stirring device, injecting the combustible gas by means of a gas inlet, and adding the rock debris multiple times by means of a feed inlet until foaming is completed.

6. The pre-split roof caving method based on the collaboration of foam fracturing and blasting for coal mines according to claim 1, wherein the combustible gas is acetylene.

7. The pre-split roof caving method based on the collaboration of foam fracturing and blasting for coal mines according to claim 1, wherein the fracturing system comprises a fracturing operation control system, a high-pressure pump, a fracturing line, an electric ignition device and a storage container, the storage container has a sealed state and is used for storing the foamed foam fracturing fluid, the fracturing line has an end connected to the storage container as well as an end stretching into the borehole, the high-pressure pump is arranged on the fracturing line, an electric ignition connecting wire of the electric ignition device is laid in the borehole together with a high-pressure line, and the fracturing operation control system is electrically connected to the high-pressure pump and the electric ignition device and used for controlling on/off and an operating pressure of the high-pressure pump and operation of the electric ignition device.
